(19) United States
(12) Patent Application Publication
(10) Pub. No.: US 2024/0332483 A1
(43) Pub. Date: Oct. 3, 2024

(54) FABRICATION OF BATTERY ELECTRODES

(71) Applicant: Pacesetter, Inc., Sylmar, CA (US)

(72) Inventor: Xiaofei Jiang, Clemson, SC (US)

(21) Appl. No.: 18/593,936

(22) Filed: Mar. 3, 2024

Related U.S. Application Data
(60) Provisional application No. 63/455,248, filed on Mar. 28, 2023.

(51) Int. Cl. H01M 4/04

(52) U.S. Cl. CPC H01M 4/0404

(57) ABSTRACT

Preparing a battery electrode includes preparing a slurry having a solid content less than 80 wt %. The slurry includes ingredients in one or more solvents. The ingredients are components of an active medium of the battery electrode. The slurry is mixed so as to apply a shear rate higher than 94200/minute to the slurry and form a mixed slurry. The ingredients are separated from the one or more solvents in the mixed slurry. The ingredients are applied to a current collector after the ingredients are separated from the one or more solvents in the mixed slurry.

### RELATED APPLICATION

The patent application claims the benefit of U.S. Patent Application Ser. No. 63/455,248, filed on Mar. 28, 2023, entitled “Fabrication Of Battery Electrodes” and incorporated herein it its entirety.

### FIELD

The invention relates to electrochemical devices. In particular, the invention relates to batteries.

### BACKGROUND

Battery electrodes commonly have an active medium on a current collector. The active medium includes an active material and can optionally include one or more other ingredients such as binders, diluents, conductors and additives. These materials are often powders that can be bound together by the binder.

Calendar sheeting and pressed powder processes are examples of processes that can be used in the fabrication of an active medium from powered materials. The pressed powder processes offer a cost effective way for electrode manufacture. Pressed powder process often employs multiple stages of powder mixing using a ball mill or low to medium speed overhead mixer. However, the use of a ball mill or low to medium speed overhead mixer can take more than a day to produce the degree of granulation needed for the active medium. Additionally, the low efficiency of the mixing method can result in inhomogeneous powder mixing and undesirably low mechanical integrity. As a result, there is a need for a more efficient method of mixing powdered ingredients for the active media in battery electrodes.

### SUMMARY

Preparing a battery electrode includes preparing a slurry having a solid content less than 80 wt %. The slurry includes ingredients in one or more solvents. The ingredients are components of an active medium to be included on the battery electrode. The slurry is mixed so as to form a mixed slurry. The ingredients are separated from the one or more solvents in the mixed slurry. The ingredients are applied to a current collector after being separated from the one or more solvents.

Another embodiment of preparing a battery electrode includes preparing a slurry having ingredients in one or more solvents. The ingredients are components of an active medium of the battery electrode. The slurry is mixed so as to apply a shear rate higher than 94200/minute to the slurry and form a mixed slurry. The ingredients are separated from the one or more solvents in the mixed slurry.

Another embodiment of preparing a battery electrode includes preparing a slurry having a solid content less than 80 wt %. The slurry includes ingredients in one or more solvents. The ingredients are components of an active medium of the battery electrode. The slurry is mixed so as to apply a shear rate higher than 94200/minute to the slurry and form a mixed slurry. The ingredients are separated from the one or more solvents in the mixed slurry.

### BRIEF DESCRIPTION OF THE FIGURES

FIG. 1 is a cross section of a generalized example of a battery.

FIG. 2 is a flow diagram for one example of a method that includes forming a cathode active medium and/or an anode active medium for use in a battery electrode.

FIG. 3A through FIG. 3C illustrate an example of a high shear mixer suitable for use in mixing the slurry.

FIG. 3A is a schematic of the mixer.

FIG. 3B is a cross section of a mixing head shown in FIG. 3A taken along the line labeled B in FIG. 3A. The mixing head includes a rotor and a stator.

FIG. 3C is an expanded view of a portion of a shear zone in the cross section of FIG. 3B.

FIG. 3D is another embodiment of a cross section of the mixing head shown in FIG. 3A taken along the line labeled B in FIG. 3A.

FIG. 4 is a graph of voltage versus capacity for a working example of battery cells.

### DESCRIPTION

Preparing an active medium for a battery electrode includes preparing a low viscosity slurry that includes the ingredients for the active medium in one or more solvents. For instance, the slurry can be prepared with a solid content less than 80 wt %. The slurry is mixed so as to homogenize the slurry. When the slurry has a solid content greater than 80 wt %, the slurry is often difficult or even impossible to homogenize. The reduced viscosity of the slurry allows the slurry to be mixed at a high shear rate. The combination of the reduce viscosity and high shear rate provides for a highly efficient mixing process. As a result, the mixing time needed to achieve a homogenous slurry can often be on the order of several minutes. The active material ingredients can be separated from excess solvent in the slurry using processes such as filtration. The active material ingredients can then be processed so as to form the active medium. The increase in efficiency associated with mixing active material ingredients greatly reduces the time needed to go from the active material ingredients in their powdered form to the active medium. For instance, the active medium can often be prepared from active material ingredients in their powdered form in less than 10 hours.

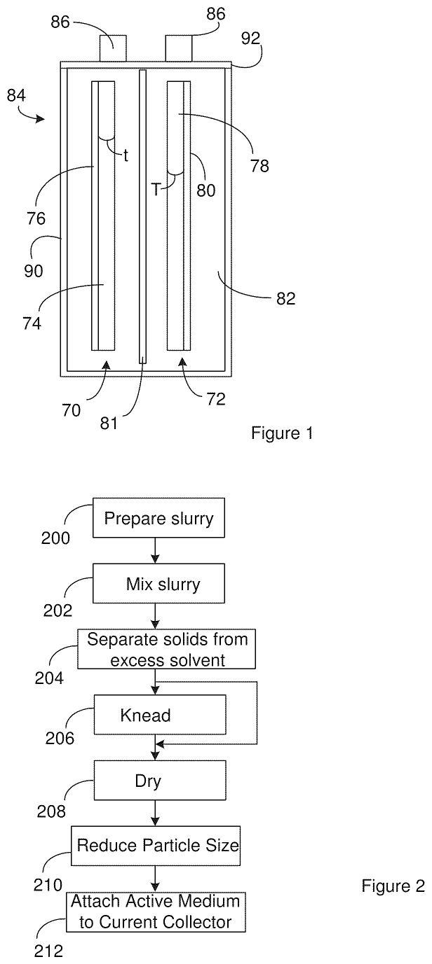

FIG. 1 is a cross section of a generalized example of a battery. The battery includes one or more first electrodes 70 alternated with one or more second electrodes 72. The first electrodes 70 include a first active medium 74 on a first current collector 76 and the second electrodes 72 include a second active medium 78 on a second current collector 80. The first electrodes 70 can be cathodes and the second electrodes 72 can be anodes or the first electrodes 70 can be positive electrodes and the second electrodes 72 can be negative electrodes. One or more of the first electrodes and/or one or more of the second electrodes can be fabricated according to the disclosed fabrication process.

A separator 81 is positioned between adjacent first electrodes 70 and second electrodes 72. An electrolyte 82 is positioned in a container 84 so as to activate the one or more first electrodes 70 and the one or more second electrodes 72. In some instances, the container 84 includes a cover 92 on a case 90. The battery includes one or more terminals 86 that can be accessed from outside of the container 84. Although not illustrated, the one or more first electrodes 70 are in electrical communication with one of the terminals 86 and the one or more second electrodes 72 are in electrical communication with another one of the terminals 86. In some instances, the one or more first electrodes 70 are in electrical communication with all or a portion of the container 84 and/or the one or more second electrodes 72 are in electrical communication with all or a portion of the container 84. In some instances where the one or more first electrodes 70 and/or the one or more second electrodes 72 are in electrical communication with the container 84, the container 84 or the case 90 serves as one or both of the terminals.

Although the battery is illustrated with the one or more first electrodes 70 and the one or more second electrodes 72 in a stacked configuration, the one or more first electrodes 70 and the one or more second electrodes 72 can be in another configuration such as a jellyroll configuration.

When the one or more first electrodes 70 is a cathode, the first active medium can be a cathode active medium that includes one or more cathode active materials. Examples of suitable cathode active materials include, but are not limited to, silver vanadium oxide (SVO), copper vanadium oxide, manganese dioxide, copper silver vanadium oxide (CSVO), carbon, fluorinated carbon, metal oxide and carbon monofluoride (CFx), metal oxide and carbon monofluoride, mixed SVO and CFx, cobalt oxide and nickel oxide, titanium disulfide, mixtures thereof. In addition to the one or more cathode active materials, the first active medium includes none, one, or more than one ingredient selected from the group consisting of binders, electrical conductors, diluents, and other additives that are not binders, electrical conductors, or diluents. Suitable binders include, but are not limited to, polymeric binders including fluoro-resin binders such as polytetrafluoroethylene (PTFE), polyvinylidene fluoride (PVDF), polyethylenetetrafluoroethylene (ETFE), a polyamide or a polyimide, and mixtures thereof. Suitable electrical conductors include, but are not limited to, acetylene black, carbon black, graphite, and metal powders of nickel, aluminum, titanium and stainless steel. Suitable additives include, but are not limited to, surfactants.

In some instances, a cathode active medium is prepared such that cathode active materials are more than 50 wt %, 80 wt % or 90 wt % and less than 98 wt %, 96 wt %, or 94 wt % of the cathode active medium. In some instances, the cathode active medium is prepared such that any binders in the cathode active medium add up to greater than or equal to 1 wt %, 2 wt %, or 3 wt % and less than 20 wt %, 10 wt %, or 6 wt % of the cathode active medium. In some instances, a cathode active medium is prepared such that any electrical conductors in the cathode active material add up to greater than or equal to 0 wt %, 1 wt %, or 2 wt % and less than 20 wt %, 10 wt %, or 6 wt % of the cathode active medium. In some instances, a cathode active medium is prepared such that any additives that are in the cathode active medium but are not a binder, an electrical conductor or a diluent add up to greater than or equal to 0 wt %, 0.1 wt %, 0.5 wt % and less than 5 wt %, 4 wt %, or 2 wt % of the cathode active medium. In one example, a cathode active medium is prepared such that the cathode active materials are more than 90 wt % and less than 96 wt % of the cathode active medium, any binder is greater than or equal to 2 wt % and less than 4 wt % of the cathode active medium, any electrical conductor is greater than or equal to 2 wt % and less than 6 wt % of the cathode active medium, and any additives that are not a binder, electrical conductor or diluent add up to greater than or equal to 0 wt % and less than 2 wt % of the cathode active medium. These ratios of the ingredients in the cathode active medium can also represent the ratios between the medium ingredients in the slurry used to form the cathode active medium.

When the one or more first electrodes 70 is a cathode, suitable first current collectors include, but are not limited to, meshes, screens, and foils. Suitable materials for the first current collector include, but are not limited to, copper, nickel, and nickel-plated steel, stainless steel, titanium, and combinations thereof.

When the one or more second electrodes 72 is an anode, the second active medium can be a cathode active medium that includes one or more anode active materials. Suitable anode active materials include, but are not limited to, materials capable of intercalating and de-intercalating lithium ions such as lithium metal and carbonaceous materials including any of the various forms of carbon such as coke, graphite, acetylene black, carbon black, glassy carbon, pitch carbon, synthetic carbon, mesocarbon microbeads, and mixtures thereof. In addition to the one or more anode active materials, the second active medium includes none, one, or more than one ingredient selected from the group consisting of binder, and electrical conductor. Suitable binders include, but are not limited to, polymeric binders including fluoro-resin binders such as polytetrafluoroethylene (PTFE), polyvinylidene fluoride (PVDF), polyethylenetetrafluoroethylene (ETFE), a polyamide or a polyimide, and mixtures thereof. Suitable electrical conductors include, but are not limited to, carbon black and graphite. Suitable additives include, but are not limited to, carbon nanotubes and graphene.

In some instances, an anode active medium is prepared such that anode active materials are more than 80 wt %, 90 wt %, or 94 wt % and less than 98 wt %, 97 wt %, or 96 wt % of the anode active medium. In some instances, an anode active medium is prepared such that any binders in the anode active material add up to greater than or equal to 2 wt %, 3 wt %, or 4 wt % and less than 20 wt %, 10 wt %, or 8 wt % of the anode active medium. In some instances, an anode active medium is prepared such that any electrical conductors in the anode active material add up to greater than or equal to 0 wt %, 2 wt %, or 4 wt % and less than 20 wt %, 10 wt %, or 8 wt % of the anode active medium. In some instances, an anode active material is prepared such that any additives that are in the anode active material but are not a binder, an electrical conductor add up to greater than or equal to 0 wt %, 0.1 wt %, or 0.5 wt % and less than 5 wt %, 4 wt %, or 2 wt % of the anode active medium. In one example, an anode active medium is prepared such that the anode active materials are more than 90 wt % and less than 94 wt %, any binder is greater than or equal to 2 wt % and less than 6 wt %, any electrical conductor is greater than or equal to 2 wt % and less than 6 wt %, and any additives that are not a binder, electrical conductor or diluent add up to greater than or equal to 0 wt % and less than 2 wt % of the anode active medium. These ratios between the ingredients in the anode active medium can also represent the ratios between the medium ingredients in the slurry used to form the anode active medium.

When the one or more second electrodes 72 is an anode, suitable second current collectors include, but are not limited to, meshes, screens, and foils. Suitable materials for the second current collector include, but are not limited to, copper, nickel, and nickel-plated steel, stainless steel, titanium, and combinations thereof.

Suitable electrolytes include, but are not limited to, electrolytes having one or more salts dissolved in one or more solvents. Suitable salts include, but are not limited to, alkali metal salt including LiPF₆, LiBF₄, LiAsF₆, LiSbF₆, LiCIO₄, LiAICI₄, LiGaCl₄, LiC(SO₂CF₃)₃, LiNO₃, LIN (SO₂CF₃)₂, LiSCN, LiO₃SCF₂CF₃, LiC₆F₅SO₃, LiO₂CCF₃, LiSO₃F, LIB (C₆H₅)₄, LiCF₃SO₃, and mixtures thereof. Suitable solvents include, but are not limited to, aprotic organic solvents including low viscosity solvents and high permittivity solvents and mixture of aprotic organic solvents that include a low viscosity solvent and a high permittivity solvent. Suitable low viscosity solvents include, but are not limited to, esters, linear and cyclic ethers and dialkyl carbonates such as tetrahydrofuran (THF), methyl acetate (MA), diglyme, trigylme, tetragylme, dimethyl carbonate (DMC), 1,2-dimethoxy-ethane (DME), 1,2-diethoxyethane (DEE), 1-ethoxy,2-methoxyethane (EME), diethyl carbonate, ethyl methyl carbonate, and mixtures thereof. Suitable high permittivity solvents include, but are not limited to, cyclic carbonates, cyclic esters and cyclic amides such as propylene carbonate (PC), ethylene carbonate (EC), acetonitrile, dimethyl sulfoxide, dimethyl formamide, dimethyl acetamide, y-valerolactone, y-butyrolactone (GBL), N-methyl-pyrrolidinone (NMP), and mixtures thereof.

Suitable separators include, but are not limited to, fabrics woven from fluoropolymeric fibers including polyvinylidene fluoride, polyethylenetetrafluoroethylene, and polyethylenechlorotrifluoro-ethylene used either alone or laminated with a fluoropolymeric microporous film, non-woven glass, polypropylene, polyethylene, glass fiber materials, ceramics, a polytetrafluoroethylene membrane commercially available under the designation ZITEX (Chemplast Inc.), a polypropylene membrane commercially available under the designation CELGARD (Celanese Plastic Company, Inc.) and a membrane commercially available under the designation DEXIGLAS (C.H. Dexter, Div., Dexter Corp.).

In one example of the battery where the first electrode is a cathode and the second electrode is an anode, the first active medium includes silver vanadium oxide (SVO) as the first active material, polytetrafluoroethylene (PTFE) as the binder, and graphite and carbon black as electrical conductors; lithium metal as the second active medium; a polymeric separator; and an electrolyte that is 0.8M to 1.5M LiAsF₆ or LiPF₆ dissolved in a 50:50 mixture, by volume, of propylene carbonate as a preferred high permittivity solvent and 1,2-dimethoxyethane as a low viscosity solvent.

FIG. 2 is a flow diagram for one example of a method that includes forming a cathode active medium and/or an anode active medium for use in a battery electrode. At process block 200, a slurry is prepared. The slurry includes the medium ingredients that will serve as the components that are to be present in the first active medium and/or the second active medium. For instance, when fabricating a first active medium for a cathode, the medium ingredients can include the one or more cathode active materials and none, one, or more than one ingredient selected from the group consisting of binders, electrical conductors, and one or more additives. When fabricating a second active medium for an anode, the slurry can include the one or more anode active materials and none, one, or more than one ingredient selected from the group consisting of binders, electrical conductors, diluents, and one or more additives. Each of the medium ingredients can be in a solid form such as a powder.

The slurry includes one or more slurry solvents in addition to the medium ingredients. The one or more slurry solvents are present in the slurry in an amount that provides the slurry with a solid content less than 80 wt %, 65 wt %, or 60 wt % when the slurry is homogenized. Homogenization occurs when the concentration of each of the slurry components is uniform across the slurry. In some instances, the slurry is prepared such that the one or more slurry solvents are more than 10 wt %, 20 wt %, or 30 wt % and less than 80 wt %, 70 wt %, or 60 wt % of the slurry. The relative ratios of the different components in the medium ingredient components can be the same or substantially the same in the slurry as in the desired active medium. Suitable slurry solvents include, but are not limited to, Isopar, NMP, ethanol alcohol, isopropanol alcohol, water, or the combination of two or more of these.

The process flow can proceed from process block 200 to process block 202. At process block 202, the slurry is mixed so as to homogenize the components of the slurry. A suitable method for mixing the slurry is the use of a mixer. Suitable mixers include, but are not limited to, high shear mixers. Accordingly, the mixing can occur under high shear conditions. For instance, the mixing can apply a shear rate greater than 94200/minute to at least a portion of the slurry. The mixing of the slurry continues until the slurry is homogenized.

After mixing, the slurry includes a solid phase in contact with a liquid phase that includes the one or more slurry solvents. The process flow can proceed from process block 202 to process block 204. At process block 204, the solid phase can be separated from all or a portion of the liquid phase so as to form a slurry cake that includes at least a portion of the solids from the slurry. For instance, the slurry cake can include particles that include or consist of the solids from the slurry. The slurry cake can include air and/or the one or more slurry solvents between the particles. Suitable approaches for separating all or a portion of the solid phase from the liquid phase include, but are not limited to, filtration methods that separate solids and liquids such as vacuum filtration, centrifuge filtration, and filter pressing. In general, the slurry cake is wet due to the presence of the one or more slurry solvents between the particles in the slurry cake.

The process flow can optionally proceed from process block 204 to process block 206. At process block 206, the slurry cake can optionally be kneaded process to fibrillate the binder material and improve the binding strength of the binder. Suitable approaches to kneading the slurry cake include, but are not limited to, hand kneading, arbor press kneading, roller kneading, and kneading in a mixer. Examples of suitable mixers for kneading include, but are not limited to, planetary double blade mixers such as a CMC planetary mixer sold by Custom Milling and Consulting LLC located in Fleetwood, PA.

The process flow can proceed from process block 204 or process block 206 to process block 208. The slurry cake can be dried at process block 208. The drying can relax the binder material and/or remove all or a portion of the one or more slurry solvents from the slurry cake. Suitable drying processes include, but are not limited to, annealing. Examples of suitable annealing temperatures include, but are not limited to, temperatures greater than 100° C., 110° C., or 120° C. and less than 320° C., 310° C. or 300° C. Examples of a suitable duration for the exposure of the granular material to the annealing temperature includes, but is not limited to, times greater than 15 min, 30 min, or 60 min and less than 24 h, 12h, 6h. In some instances, the annealing conditions can be a function of the binder present in the granular material. For instance, a suitable annealing temperature when the slurry cake includes a binder that includes or consists of PTFE is between 250° C. to 300° C. When the drying processes include annealing, a secondary drying operation can optionally be performed before or after the annealing. For instance, the slurry cake can be heated to a secondary drying temperature above room temperature for a secondary drying time period. Suitable secondary drying temperatures include, but are not limited to, temperatures greater than 100° C., 110° C., or 120° C. and less than 320° C., 310° C. or 300° C. Suitable secondary drying time periods include, but are not limited to, times greater than 15 min, 30 min, or 60 min and less than 24 h, 12h, 6h. In one example of drying the slurry cake at process block 208, a secondary drying operation is performed pm the slurry cake at 120° C. for 6h and the slurry cake is annealed at 280° C. for 15 min.

The process flow can proceed from process block 208 to process block 210. At process block 210, the size of the particles in the slurry cake can be reduced so as to generate an active medium powder with particles having the desired average widths. For instance, the slurry cake can be pelletized or pulverized to a powder with particles having the targeted average widths. Examples of suitable mechanisms for pelletizing the slurry cake include, but are not limited to, a coffee grinder and a pelletizer such as a Fitzpatrick SLS-0054 with U5 Comil head as sold by The Fitzpatrick Company located in Westwood, MA. In some instances, providing the active medium powder with the desired width distribution can include passing active medium powder through one or more sieves to eliminate larger particles. Suitable average particle widths for the active medium powder include, but are not limited to, widths greater than 50 μm, 100 μm, or 200 μm and less than 500 μm, 1000 μm, or 2000 μm.

The process flow can proceed from process block 210 to process block 212. At process block 212, the active medium powder can be attached to a current collector. For instance, when the active medium powder includes the ingredients for the first active medium 74, the active medium powder can be attached to a first current collector 76. When the active medium powder includes the ingredients for the second active medium 78, the active medium powder can be attached to a second current collector 80.

The active medium powder can be attached to a current collector so as to form a layer of active medium on the current collector. For instance, the active medium powder can be attached to a second current collector 80 so as to form the second active medium 78 on the second current collector 80. Alternately, the active medium powder can be attached to a first current collector 76 so as to form the first active medium 74 on the first current collector 76. A suitable approach for attaching an active medium powder to a current collector includes pressing the active medium powder onto the current collector so as to form the layer of the active medium on the current collector. In some instances, pressing drives the active medium powder into openings on the current collector and can leave the current collector embedded in the active medium powder. For instance, when the current collector is a screen or mesh, the active medium powder can be pressed onto the current collector so as to embed the current collector in the active medium powder.

In some instances, attaching an active medium powder to a current collector includes further drying of the active medium on the current collector. The drying can eliminate any leftover moisture, and release stress inside the electrode. Suitable drying processes include, but are not limited to, annealing. Examples of suitable annealing temperatures include, but are not limited to, temperatures greater than 80° C., 100° C., or 120° C. and less than 250° C., 220° C., or 200° C. Examples of a suitable duration for the exposure of the granular material to the annealing temperature includes, but is not limited to, times greater than 15 min, 30 min, or 60 min and less than 12 h, 10 h, or 6 h.

In some instances, the combination of the active medium powder and the attached current collector serves as an electrode. For instance, in some instances, the active medium powder attached to a second current collector 80 can serve as a second electrode 72. In some instances, the active medium powder attached to a first current collector 76 can serve as a first electrode 70. As a result, a battery can be assembled using one or more of the electrodes fabricated as disclosed in the context of FIG. 2.

The process flow of FIG. 2 can be highly desirable for the formation of thick active media because the powder can be evenly spread during electrode pressing. The thickness of the first active medium 74 and the second active medium 78 are labeled t and T respectively in FIG. 1. In some instances, the thickness of the first active medium is greater than 0.005″, 0.010″, or 0.015″ and less than 0.250″, 0.200″, or 0.100″ and/or the thickness of the second active medium is greater than 0.005″, 0.010″, or 0.015″ and less than 0.250″, 0.200″, or 0.100″.

The process flow of FIG. 2 greatly reduces the time needed to go from the powdered form of the medium ingredients to the active medium. For instance, the combination of the reduced viscosity provided by the reduced solids content and high shear rate provides for a highly efficient mixing process. As a result, the time needed to go from powdered form of the medium ingredients to a homogenous slurry can often be greater than 0.5 min, 1 min, or 2 min and less than 15 min, 10 min or 5 min. The time needed to separate the medium ingredients from the one or more solvents in the homogenous slurry so as to generate the granular material can be greater than 1 min, 2 min, or 3 min and less than 15 min, 10 min, or 5 min. When the granular material is kneaded, the duration of the kneaded can be greater than 0.5 min, Imin, or 2 min and less than 10 min, 6 min, or 4 min. The time to perform additional processing of the granular material so as to form the active medium powder from the kneaded or unkneaded granular material, can be greater than 1 min, 2 min, or 3 min and less than 10 min, 8 min, or 6 min. As a result, the total time needed to go from the powdered form of the medium ingredients to the active medium can be greater than 2 h, 3 h, or 4 h and less than 10 h, 8 h, or 6 h whether the active medium is attached to a current collector or is independent of the current collector.

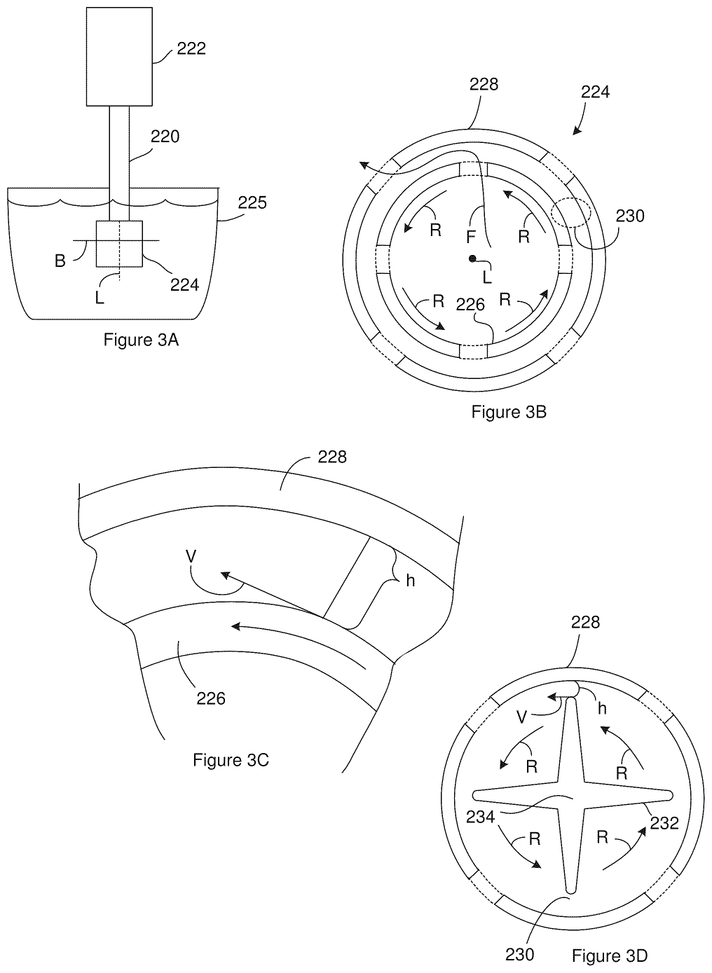

FIG. 3A through FIG. 3C illustrate an example of a high shear mixer suitable for use in mixing the slurry. FIG. 3A is a schematic of the mixer. FIG. 3B is a cross section of the mixer shown in FIG. 3A taken along the line labeled B in FIG. 3A. FIG. 3C is an expanded view of a portion of a shear zone in the cross section of FIG. 3B. The mixer includes a shaft 220 that connects a motor 222 and a mixing head 224. In FIG. 3A, the mixing head 224 is shown positioned in a slurry that is contained within a container 225.

The mixing head includes a rotor 226 and a stator 228. In FIG. 3B, the stator 228 is illustrated as surrounding the rotor, however, other configurations are possible. The motor is configured to rotate around a longitudinal axis labeled L in FIG. 3A and FIG. 3B. The rotation is illustrated by the arrows labeled R in FIG. 3B. The shaft holds the stator in a stationary position during the rotation of the rotor. As a result, a shear zone 230 is defined between the rotor and the stator. During operation of the mixer, the portion of the slurry on the shear zone is subjected to shear strain.

The dashed lines in FIG. 3B illustrate fluid passageways through the rotor 226 and the stator 228. Suitable fluid passageways include, but are not limited to, openings in the wall of the rotor 226 and/or the stator 228, gaps between different walls of the rotor 226 and/or the stator 228. In some instances, a screen or mesh is positioned in the fluid passageways.

During operation of the mixer, the slurry can flow into the shear zone 230 from above or below the mixing head. Additionally or alternately, as shown by the arrow labeled F in FIG. 3B, the slurry can flow from a reservoir within the rotor 226, through one or more of the fluid passageways in the rotor into the shear zone 230. The slurry can flow out of the shear zone through one or more of the fluid passageways in the stator.

In the mixing head of FIG. 3A through FIG. 3C, the outer surface of the rotor drives movement of the slurry in the shear zone. However, other rotor configurations are possible. For instance, suitable rotors include, but are not limited to, impellers. As a result, movement of the slurry in the shear zone can be driven by one or more fins, one or more blades, one or more baffles, and/or one or more extremities of a geometrically shaped rotor. In some instances, the fins, blades, baffles, and/or extremities extend outward from a central hub that is driven by the motor or extend inward from a frame that is driven by the motor. As an example, FIG. 3D illustrates another example of a rotor that includes four fins 232 that that extend outward from a hub 234 that is driven by the motor. The motor drives the hub such that the fins rotate around the hub in the direction of the arrows labeled R.

As is evident in FIG. 3C and FIG. 3D, the outermost surface, corner, or edge of the rotor is spaced apart from the stator by a gap labeled h. The gap can be greater than 0″, 0.150″, or 0.250″ and less than 1.000″, 0.800″, or 0.500″. During operation of the mixer, the outer surface of the rotor moves at a speed labeled V. When the movement of the outer surface of the rotor is circular, the speed can be the tangential speed of the outer surface of the rotor. The speed can be greater than 47100 Inches Per Minute (IPM), 56520IPM, or 75360IPM and less than 188400IPM, 150720IPM, or 113040IPM. Accordingly, a tangential speed of at least a portion of the rotor during the mixing can be greater than 47100IPM. Depending on the dimensions of the rotor, these speeds can be achieved by rotating the rotor at rotational speeds greater than 5000 rpm, 6000 rpm, or 8000 rpm and less than 20000 rpm, 16000 rpm, or 12000 rpm. The shear rate applied to the slurry can be calculated as γ=V/h where y represents the shear rate. When the mixer is a high shear mixer, the mixer can be operated such that the shear rate is greater than 94200/minute, 113040/minute, or 150720/minute and less than 376800/minute, 301440/minute, or 226080/minute. In some instances, the shear rate is selected such that there is turbulent flow in the shear zone.

Although FIG. 3A through 3D are illustrated as having a stator, there are high shear mixers that do not make use of a stator. These mixers use a high shear blade and can also be used to mix the slurry by operating them such that the shear rate applied to the slurry is greater than 94200/minute, 113040/minute, or 150720/minute and less than 376800/minute, 301440/minute, or 226080/minute.

Although the mixer of FIG. 3A through FIG. 3C is illustrated with the rotor in an interior of the stator, the illustrated positions of the rotor and stator can be switched. For instance, the stator can be in an interior of the rotor.

Suitable high shear mixers include, but are not limited to, homogenizers, kitchen mixers, and blenders. Specific examples of shear mixers include, but are not limited to, the model Physcotron homogenizer sold by Microtech Co. Ltd. located in Chiba Japan, the MiniPro MX070 emulsifier sold by Dynamic Mixer located in Memphis, TN, and the Waring Xtreme sold by Waring.

The mixer and container in FIG. 3A are suitable for mixing the slurry in a batch process; however, the low viscosity and short mixing time make the method suitable for adaptation to inline and/or continuous processes. Accordingly, all or a portion of the method of active medium preparation can be an inline and/or continuous process.

### Example 1

A slurry having 90 g CFx, 6 g carbon black, and 4 g PTFE was mixed with 250 g Isopar in a Waring Xtreme MX1300XTXP blender for 70s at a speed of 16000 rpm. The solid content was 28.5%, and the shear rate was 301440/minute. Isopar in the slurry was extracted using a Rousselet Robatel RA20Vx Centrifuge for 90s at 3000 rpm speed. The cathode mix cake was kneaded in a CMC planetary mixer for 60s at 40 rpm. After kneading, the cathode mix cake was dried in 120° C. oven for 6h, followed by annealing in 280° C. oven for 15 minutes. The dried cathode mix cake was pelletized in a Waring WSG60 Powder Grinder for 15s. The pelletized cathode powder was pressed on to a current collector and assembled in battery cells.

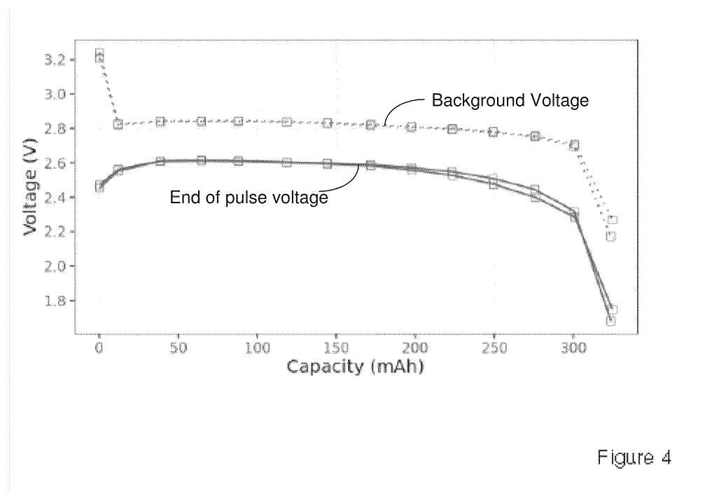

A 3 month 37° C. test was performed on two of the cells. A resistance load of 18200 ohm was attached to the cell as a continuous background load. The cells were kept in 37° C. thermal chamber and tested with a set of 3 mA/8 mA pulse train for 180s once per week for each week of the test. The background cell voltage before the pulse train and the end of pulse voltage were recorded against the delivered cell capacity and plotted in FIG. 4. The cell shows stable background voltage around 2.8V over the full capacity range. Additionally, the high “end of pulse voltage” from beginning of service (BOS) to the end of service (EOS) shows desirable high rate pulse performance. Accordingly, the cell achieved desirable performance levels with only 70 seconds of slurry mixing time.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A method of preparing a battery electrode, comprising:
preparing a slurry having a solid content less than 80 wt %, the slurry including ingredients in one or more solvents, the ingredients being components of an active medium of the battery electrode;
mixing the slurry so as to form a mixed slurry;
separating the ingredients from the one or more solvents in the mixed slurry; and
applying the ingredients to a current collector after separating the ingredients from the one or more solvents.

2. The method of claim 1, wherein mixing the slurry includes applying a shear rate higher than 94200/minute to the slurry.

3. The method of claim 2, wherein the one or more solvents are at least 40 wt % of the slurry.

4. The method of claim 1, wherein mixing the slurry includes using a high shear mixer.

5. The method of claim 4, wherein the high shear mixer includes a rotor and a stator.

6. The method of claim 5, wherein the rotor is positioned in an interior of the stator.

7. The method of claim 5, wherein the stator is within 0.5″ of at least a portion of the rotor.

8. The method of claim 5, wherein a tangential speed of at least a portion of the rotor during the mixing is greater than 47100 inches per minute.

9. The method of claim 5, wherein the rotor is rotated at least 5000 rpm during the mixing.

10. The method of claim 1, wherein separating the ingredients from the one or more solvents in the mixed slurry includes filtering the mixed slurry.

11. A method of preparing a battery electrode, comprising:
preparing a slurry having ingredients in one or more solvents, the ingredients being components of an active medium of the battery electrode;
mixing the slurry so as to apply a shear rate higher than 94200/minute to the slurry and form a mixed slurry;
separating the ingredients from the one or more solvents in the mixed slurry; and
applying the ingredients to a current collector after separating the ingredients from the one or more solvents.

12. The method of claim 11, wherein the one or more solvents are at least 20 wt % of the slurry.

13. The method of claim 11, wherein mixing the slurry includes using a high shear mixer.

14. The method of claim 13, wherein the high shear mixer includes a rotor and a stator.

15. The method of claim 14, wherein the rotor is positioned in an interior of the stator.

16. The method of claim 14, wherein the stator is within 0.5″ of at least a portion of the rotor.

17. The method of claim 14, wherein a tangential speed of at least a portion of the rotor during the mixing is greater than 47100 inches per minute.

18. The method of claim 14, wherein the rotor is rotated at least 5000 rpm during the mixing.

19. The method of claim 11, wherein separating the ingredients from the one or more solvents in the mixed slurry includes filtering the mixed slurry.

20. The method of claim 11, wherein a duration of mixing the slurry is less than 5 minutes.
